(19) United States
(12) Patent Application Publication
(10) Pub. No.: US 2021/0350088 A1
(43) Pub. Date: Nov. 11, 2021

(54) SYSTEMS AND METHODS FOR DIGITAL DOCUMENT GENERATION USING NATURAL LANGUAGE INTERACTION

(71) Applicant: JPMORGAN CHASE BANK, N.A., New York, NY (US)

(72) Inventors: Vineeth RAVI, New York, NY (US); Selim AMROUNI, New York, NY (US); Andrea STEFANUCCI, Hoboken, NJ (US); Prashant P. REDDY, Madison, NJ (US); Maria Manuela VELOSO, Pittsburgh, PA (US)

(21) Appl. No.: 16/870,666

(22) Filed: May 8, 2020

(51) Int. Cl. G06F 40/56; G06F 40/284; G06F 40/216

(52) U.S. Cl. CPC G06F 40/56; G06F 40/216; G06F 40/284

(57) ABSTRACT

Systems and methods for digital document generation using natural language interaction are disclosed. In one embodiment, in an information processing apparatus comprising at least one computer processor, a method for digital document generation using natural language interaction may include: (1) receiving from an electronic device, a natural language command comprising an action to generate digital content, an object, and a data source for the digital content; (2) processing the natural language command to identify the action, the type of digital content, and the data source; (3) identifying a skill in a skill library that is mapped to the action and the object; (4) retrieving data from the data source for the skill; and (5) generating the digital content according to the skill using the data.

### BACKGROUND OF THE INVENTION

### 1. Field of the Invention

The present disclosure generally relates to systems and methods for digital document generation using natural language interaction.

### 2. Description of the Related Art

Visual presentations, such as PowerPoint presentations, are often used to present information to others. Large organizations, such as financial institutions, generate reports manually based on a tedious analysis and visualization of underlying structured data. Often, the structure of the reports and of the underlying data typically do not change; the reports are periodically updated to reflect the new data. The creation of these reports is time consuming.

### SUMMARY OF THE INVENTION

Systems and methods for digital document generation using natural language interaction are disclosed. In one embodiment, in an information processing apparatus comprising at least one computer processor, a method for digital document generation using natural language interaction may include: (1) receiving from an electronic device, a natural language command comprising an action to generate digital content, an object, and a data source for the digital content; (2) processing the natural language command to identify the action, the type of digital content, and the data source; (3) identifying a skill in a skill library that is mapped to the action and the object; (4) retrieving data from the data source for the skill; and (5) generating the digital content according to the skill using the data.

In one embodiment, the natural language command may be received as audio, as text, etc.

In one embodiment, the step of processing the natural language command to identify the action, the type of digital content, and the data source may include: parsing the natural language command into a plurality of words or phrases; tokenizing the words or phrases; and labeling the tokenized words or phrases.

In one embodiment, the object may identify automatically-creatable digital content.

In one embodiment, the method may further include training a natural language processing engine with a user preference for at least one of the action and the object.

In one embodiment, the skill may include an atomic skill or a macro skill.

In one embodiment, the method may further include increasing a probability belief score in response to a successful mapping of the action and object to the skill; and decreasing the probability belief score in response to an unsuccessful mapping of the action and object to the skill.

In one embodiment, the method may further include generating an insight for the digital content comprising textual content.

In one embodiment, the method may further include adding a new skill to the skill library based on the action and the object.

According to another embodiment, a system for digital content generation using natural language interaction may include: an interface; a parser; a mapping engine; a skill library; a document generator; and a data source. The interface may receive, from an electronic device, a natural language command comprising an action to generate digital content, an object, and a data source for the digital content. The parser may process the natural language command to identify the action, the type of digital content, and the data source. The mapper may identify a skill in the skill library that is mapped to the action and the object. The document generator may retrieve data from the data source for the skill, and may generate the digital content according to the skill using the data.

In one embodiment, the natural language command is received as audio, as text, etc.

In one embodiment, the parser may process the natural language command by: parsing the natural language command into a plurality of words or phrases; tokenizing the words or phrases; and labeling the tokenized words or phrases.

In one embodiment, the object may identify automatically-creatable digital content.

In one embodiment, the system may further include a natural language processing engine that is trained with a user preference for at least one of the action and the object.

In one embodiment, the skill may include an atomic skill or a macro skill.

In one embodiment, the document generator may increase a probability belief score in response to a successful mapping of the action and object to the skill, and may decrease the probability belief score in response to an unsuccessful mapping of the action and object to the skill.

In one embodiment, the system may further include an insights generator that generates an insight for the digital content comprising textual content.

In one embodiment, the mapping engine may add a new skill to the skill library based on the action and the object.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for digital document generation using natural language interaction according to one embodiment; and

FIG. 2 depicts a method for digital document generation using natural language interaction according to one embodiment.

### DETAILED DESCRIPTION OF PREFERRED EMBODIMENTS

Embodiments are generally directed to systems and methods for digital document generation using natural language interaction.

Embodiments may include three basic components based on symbiotic human-AI interactions: (i) automated document generation through mapping natural language, (ii) learning natural language from experience using knowledge base, and (iii) insight generation from structured data. Embodiments may use automated document generation through mapping natural language to map human language instructions to underlying “skills,” such as the ability to perform a task successfully. Examples of tasks include the generation of contents and template formatting that can be automatically executed.

Embodiments may use learning natural language from experience using knowledge base to enable robust continuous learning of mappings and skills through feedback, by prompting questions and clarifying human instructions.

Embodiments may use insight generation from structured data to generate meaningful hierarchical explanations of the data by, for example scanning and processing the data through a set of insight generators, generating explanations in the form of natural language sentences, ranking the insights based on predefined measures of relevance, and automatically generating slides to represent the prioritized trends.

Although embodiments may be described in the context of insight generators focusing on the variation of time series compared to historical values, it should be recognized that embodiments have applicability with any type of insight generator.

Embodiments provide at least some of the following technical advantages: (1) applying AI representation and robust continuous learning techniques to data, (2) allowing users to combine individual instructions in complex tasks to be saved for future use, and (3) automatically generating explanations and slides based on the trends highlighted by AI Insights.

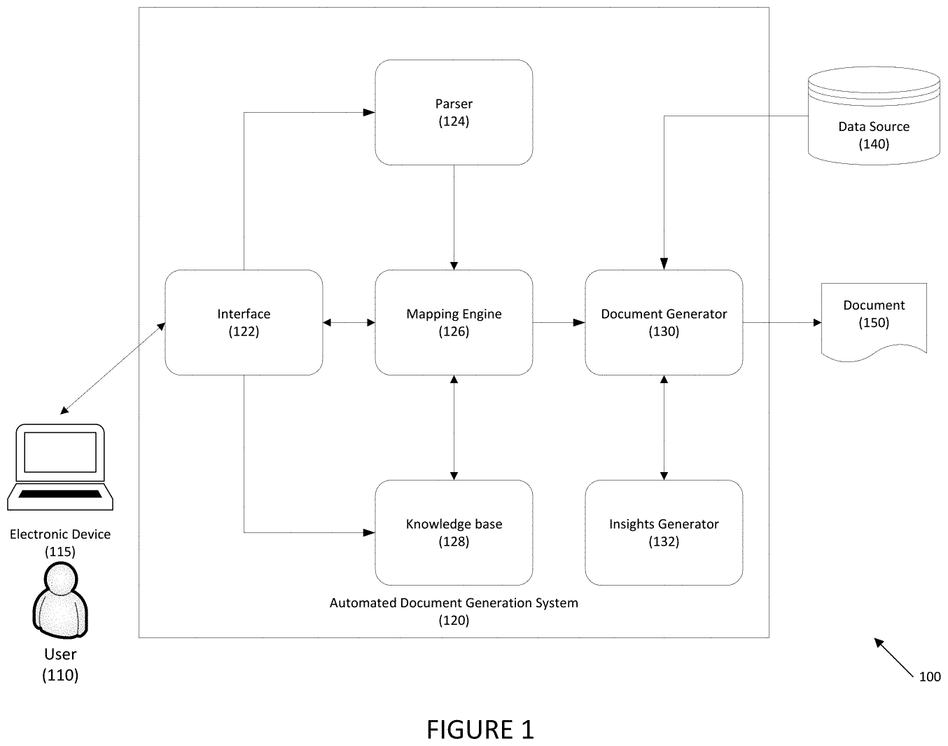

Referring to FIG. 1, a system for digital document generation using natural language interaction is disclosed according to one embodiment. System 100 may include user 110 that may access Automated Document Generation System 120 using electronic device 115. Electronic device 115 may be any suitable electronic device, including computers (e.g., notebook, desktop, laptop, tablet, etc.), smartphones, kiosks, terminals, Internet of Things (“IoT”) appliances, etc.

User 110 may issue commands to interface 122 to create and modify content using natural language.

Interface 122 may be any suitable interface for receiving commands from user 110. In one embodiment, interface 122 may be a voice or natural-language-based interface (e.g., a chat box, chat bot, etc.) that enables a natural language command to be entered given by typing, speaking, etc. and to return results to user 110.

Parser 124 may be parse, tokenize, and label user 110's natural language comments. In one embodiment, parser 124 may be based on a conditional random field (CRF) model and maybe trained. For example, parser 124 may be trained with an existing corpus (e.g., one hundred) of natural language input sentences, and labelling their individual tokens that can be used for mapping to existing skills.

A feature vector set may be created for each token (e.g., parts-of-speech tags, etc.) for training parser 124. Embodiments may use a larger corpus of sentences, may use different models (e.g., neural networks, etc.), may employ additional features to be included in the training.

For a word or token, example features include the number of letters present in the word or token, the parts-of-speech tag (e.g., noun, verb, pronoun, etc.), the first and last letter of the word or token, the resulting word resulting from removing the first or last letter of the word or token, resulting sub-words from the word or token being split up, neighboring words in the sentence in which the word or token is used, including their parts-of-speech tags, etc.

For example, for the sample sentence “Please create a piechart using Bank X data,” and the word/token “piechart,” the features may be:
Number of letters: 7;
Parts-of-Speech Tag: noun;
First and Last letters: “p” and “t”;
word removing the first letter: “iechart”;
word removing the last letter: “piechar”;
word split and broken up into 2 and 3 sub-words: “pie”, “char”, “t”, “pi”, “ch”, “ar”, “t”;
neighboring words: “a” and “using”, which are a preposition and verb, respectively; and
first and last letters of neighboring words: “a” and “u”.

The neighboring words are not limited to the immediate preceding and following words; the next two, three, four, etc. neighboring words may be used. As additional neighboring words are used, additional training data may be needed, a more advanced parser may be needed, etc.

An example of a parser with deep neural network architecture, larger training data, more features is disclosed in Perera, V. “Multi-Task Learning For Parsing The Alexa Meaning Representation Language.” AAAI Conference on Artificial Intelligence, North America, Apr. 2018. Available at: https://aaai.org/ocs/index.php/AAAI/AAAI18/paper/view/17326, the disclosure of which is hereby incorporated, by reference, in its entirety.

In addition, the token/word may be checked to see if it contains a number. The check may be binary (e.g., 0 if no number is present, 1 if number is not present.

Mapping engine 126 may map token-labels extracted from the command to a corresponding “skill.” Skills generally refer to a task or a set of tasks that can be executed automatically on behalf of the human, such as document generation.

Knowledge base 128 may save a vocabulary used by one or more user. For example, embodiments may learn from experience through interactions with user 110 that enables the learning to map natural language input to skills.

Document generator 130 may generate the requested document 150 in the appropriate format. Examples include PowerPoint, Word, Web pages, PDF's, output files (e.g., JSON requests), etc. Document generator 130 may receive input needed to generate document 150 from one or more data source 140. Data source 140 may be any suitable source of data, such as internal and external systems, databases, etc. The data may be historic data, real-time data, etc. The particular data source 140 used may depend on the type and/or purpose of document 150.

Insights generator 132 may provide automated generation of AI insights, such as texts automatically generated by the system to complete document 150 with insights. Embodiments may generate as much insights as it is possible to define by a “conceptor,” which is the end-user of the application or framework.

Insights may be scored and ranked, and the highest scoring insights may be included in the document.

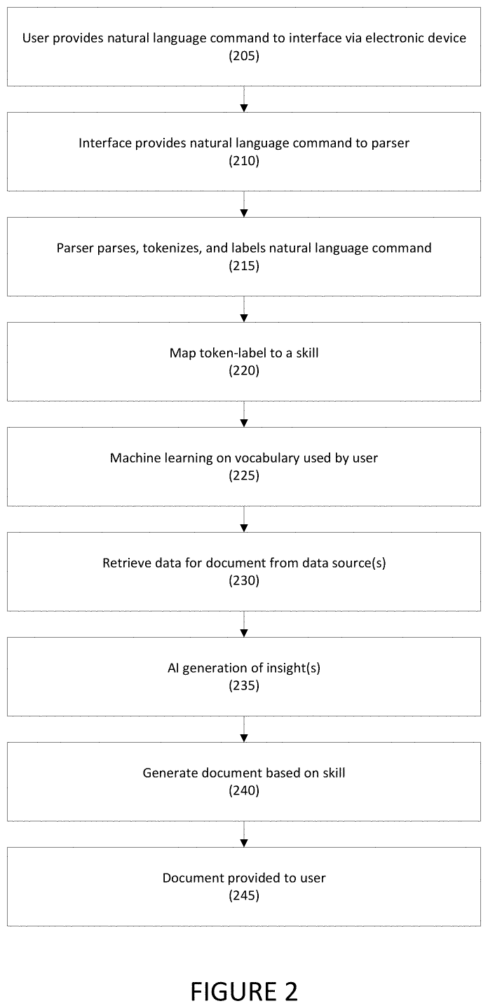

Referring to FIG. 2, a method for digital document generation using natural language interaction is disclosed according to one embodiment.

In step 205, a user may provide a natural language command to generate a document. In one embodiment, the natural language command may be typed or spoken into an electronic device, such as a computer, a smart device, an Internet of Things appliance, a terminal, a kiosk, etc. The electronic device may then provide the natural language command to an interface for an automated document generation system.

In step 210, the interface provides natural language command to parser. In this step, the interface may only provide the natural language command to parser; at a later step, if required, the interface may be part of the framework that clarifies the user's commands (e.g., if ambiguous) and may request additional input (e.g., if the user input did not include input required for the task, such as the underlying data source, the skills required, the vocabulary, etc.).

In step 215, the parser may parse, tokenize, and label the natural language command. For example, parser may parse the command by extracting certain words or phrases and tagging them with labels. These labels may be used to map the command to one or more skill that may be executed. In one embodiment, a trained frame semantic parser may be used to predict labels for natural language input.

In one embodiment, the labels may be used to identify one or more of: (i) an action (e.g., a task the user can request) such as create, modify, save, add, delete, execute, etc.; (ii) an object (e.g., content that can be automatically created), such as a pie chart, a histogram, a line graph, insights, a company briefing deck, etc.; (iii) a type of data or a data source; (iv) a presentation type (e.g. slide presentation, “weekly presentation,” monthly update, etc.; (v) conceptor defined labels (e.g., labels that are custom generated for different users or types of documents (e.g., sports documents such as football, baseball, etc., may be labelled as “sport”, finance documents such as JPMorgan, Goldman Sachs, etc., may be labelled as “Investment Banks”, etc.).

In embodiments, the parser may be trained on a certain number of natural language commands (training data) and may be annotated manually with labels that are commonly used for creating presentations.

In embodiments, the training process may include tokenizing the sentences in the command to identify a parts-of-speech (POS) tag of every token in the training data set using the natural language toolkit (NLTK) library. An example of such is described in Bird, E. “Natural language processing with Python,” (2009) the disclosure of which is hereby incorporated, by reference, in its entirety. A feature vector may then be generated for every word comprising of features based on the POS tags of the current, next, and, previous words, as well as features that are directly dependent on the current, next, and, previous words themselves.

Embodiments may use conditional random fields (CRF) as implemented in CRFsuite and called through the python-crfsuite package for training to obtain a resultant CRF model. Examples of CRF fields are disclosed in J. D. Lafferty, A. McCallum, and F. C. N. Pereira, “Conditional random fields: Probabilistic models for segmenting and labeling sequence data.” ICML '01, pages 282-289 (2001); F. Sha and F. Pereira, “Shallow parsing with conditional random fields” volume 1 of HLT-NAACL '03, pages 134-141. Association for Computational Linguistics (2003); Sutton and A. McCallum. “An introduction to conditional random fields.” Foundations and Trends in Machine Learning,” 4(4):267-373 (2012); N. Okazaki, “CRFsuite: a fast implementation of conditional random fields (CRFs)”, Aug. 2011 (http://www.chokkan.org/software/crfsuite); M. Korobov, J. Cochrane, F. Gregg, and T. Peng. “python-crfsuite: A Python binding for CRFsuite”, Aug. 2018 (https://github.com/scrapinghub/python-crfsuite). The disclosures of each of these references is hereby incorporated, by reference, in its entirety.

The weights w of each feature may be learned using the limited memory Broyden-Fletcher-Goldfarb-Shanno (L-BFGS) quasi-Newton optimization method. Examples are disclosed in J. Nocedal, “Updating quasi-Newton matrices with limited storage.” Mathematics of Computation, 35 (151):773-782 (1980) and D. C. Liu and J. Nocedal, “On the limited memory BFGS method for large scale optimization.” Mathematical Programming, 45(1):503-528, (Aug. 1989), the disclosures of which is hereby incorporated, by reference, in their entireties.

For example, the command “Please create a pie chart using energy data and add it to the weekly report,” the word “create” may be parsed to be an action, “pie chart” may be an object, “energy data” may be data, and “weekly report” may be a presentation.

In step 220, the token-label may be mapped to a skill. For example, a mapping engine may determine whether if there is a skill associated with the token-label. If there is, the skill is retrieved. If there is not, the mapping engine may request additional information from the user via the interface.

For example, the user may interact with the framework to “save” new skills that may be a combination of existing skills. If there are new skills” that cannot be created this way, then the core existing skills may be updated for future use as defined, for example, by the conceptor.

For example, the predicted output labels may be used to map human instructions to skills. In embodiment, the python-pptx library, disclosed in S. Canny, “python-pptx: Create Open XML PowerPoint documents in Python,” May 2019 (https://python-pptx.readthedocs.io/en/latest/), the disclosure of which is hereby incorporated, by reference, in its entirety, may be used to generated PowerPoint decks.

Skills may be classified into two types: atomic and macro. Atomic skills refer to tasks that create or modify the contents of one or few slides in a digital presentation from a single natural language input command from the user. The parameters of date and title in the slides as well as the location of data values in the data source files are autogenerated from templates used in recurrent reports, which are common in business teams. Examples of natural language commands for atomic skills are “Please [create]action a [Piechart]object about Energy Production using [RTE data set]data and include it in [energy report]presentation presentation” and “Please [create]action a [Histogram Comparison]object of Energy Production using [RTE data set]data and include it in [energy report]presentation presentation.”

Macro Skills may create or modify the contents of many slides or the entire digital presentation from a single natural language input command from the user. An example is the use of a template, such as a “Company Briefing Deck” of 10 slides that is generated using “Finance” data that is added to a PowerPoint presentation with name “weeklyreport”. Example natural language commands of Macro skills include “Please, can you [create]action a [CompanyBriefingDeck]object using [Finance]data data and add it in [weeklyreport]presentation deck.”

In one embodiment, skills may be saved and reused. For example, natural language commands may be logged so that the saved combination of atomic and macro skills may be reused. Saving Skills refer to tasks that allow the user to encapsulate a combination of atomic and macro skills, as a composite object. This allows the user to easily perform repetitive tasks in the future by reusing a majority of previous natural language commands. An example of a save command is “Kindly [save]action the previous [twenty]data human commands as an object with name [Company Briefing Updated]object.” This may be useful for future recurrent tasks because the user can get the new updated deck with just one single instruction instead of repeating several previously used natural language commands for creating and modifying digital documents.

In step 225, the vocabulary used by in the natural language command may be used to train a natural language processing engine using machine learning. In one embodiment, the user's preferences may also be stored in memory. For example, if a user characterizes the document to be generated as a “standard weekly report,” the document properties associated with the document may be associated with that phrase for the user.

In one embodiment, the vocabulary may be applied to other users as is necessary and/or desired.

In one embodiment, the vocabulary used by users in a large organization may be inconsistent sometimes due to cultural and language differences. For example, a “chart” may mean a “pie chart” or a “bar chart” depending on an individual user's intentions. It is difficult to have a consistent and exhaustive vocabulary mapping list across all users in a large organization. Embodiments may dynamically adapt and improve its predictions through interactions with the user for feedback, learning from experience.

In one embodiment, the knowledge base may adapt to user vocabulary continuously by using a probability Belief Score, and may forget incorrect or old/rarely used vocabulary mapping over time. Thus, new users of the framework have the advantage of using an existing rich knowledge base, as well as can contribute new vocabulary to enhance the knowledge base.

In one embodiment, on first occurrence, unique vocabulary words that are used for “skill” mapping may be assigned a constant probability belief score of “1.” As more users interact, the frequency of every word employed by the user, and the corresponding “skill” performed by the system may be recorded, and the probability belief score may be updated based on the occurring frequency of the word to “skill” mapping. If a given word has multiple mappings, occurring with equal frequency, then each mapping would be assigned equal probability Belief Scores between 0 and 1. If a mapping does not get used often, the probability Belief Score may eventually be reduced to 0, while other mappings' scores may be increased to reflect their increased probability.

For example, assuming that “piechart” and “barchart” are skills, and all the words with frequencies of use by all the users are as follows:

chart-piechart: 4;

chart-barchart: 1;

piegraph-piechart: 6;

histogram-barchart: 2.

The Probability Belief Scores are:

chart-piechart: 0.8 (i.e., 4/(4+1);

chart-barchart: 0.2 (i.e., 1/(4+1));

piegraph-piechart: 1 (i.e., 6/(6+0))′

histogram-barchart: 1 (i.e., 2/(0+2)).

In embodiments, the knowledge base may store user vocabulary and corresponding mappings to skills, and is updated continuously by interacting with multiple users by, for example, using the chat interface, where it learns new words and corresponding mappings to skills. In embodiments, mappings may be confirmed with the users by using prompts and questions.

In step 230, data for the document may be retrieved from one or more data source. The data sources may include internal, external, static, dynamic, etc. data sources. In one embodiment, the data source(s) may be selected based on the command, and any temporal requirements (e.g., a data range) may be applied as is necessary and/or desired.

In one embodiment, the data may be stored in different types of data source, including databases, relational tables, cloud storage, etc.

In step 235, artificial intelligence insights may be identified for incorporation into the document. For example, insights may be thought of as a skill that permits the framework to include text commentary in the digital document.

For example, insights may be generated from the underlying data by performing statistical analysis using various mathematical models. Examples of such comparisons include historical comparisons (e.g., year to year, quarter to quarter, etc.) on time series data. Insights may be based on anomalies in data, which may be identified and included in reports automatically. Other types of insights may be automatically identified and generated as is necessary and/or desired.

The type of insight(s) may vary depending on the purpose and requirements of the particular report being automatically generated and underlying data. For example, a sports report may include insights related to sports statistics, such as averages, mean, variance, maximums, minimums, etc., while a financial report may include commentary on fluctuations of stock prices, market trends, etc.

The framework may identify the purpose and requirements of the report based on, for example, the end-user, the underlying raw-data, tertiary parameters that may be set in the system during interaction, etc. For example, if a user generally creates piecharts, and includes sports insights, embodiments may identify this as a new skill and automatically chose to include such insights when that user interacts with the system. The user may, however, vary the type of insight generated in the report. For example, the user may identify the insight(s) to be included to the system, and the system may convert the insights to natural language.

Initially the “text-commentary” that is included as insights may be based on default and conditional templates. Each word, punctuation, conjunction etc. that is generated as part of “text-commentary” insights is based on logical or conditional parameters being triggered to include them as part of the whole insight. The kind of words, and the logical or conditional parameters, may vary depending on the type of insight or end-user. For example, financial insights may have language such as “drivers/offsets”, “profits/loss,” etc. The word “large” may be included in the insight sentence if the profits exceed a certain amount. A sports insight may include language such as “games”, “football,” etc. The word “tie” may be included if both teams in a game have the same score/points.

In embodiments, multiple insights may be generated, and the process may be repeated for each insight. The insights may be ranked based on, for example, magnitude or any other logical/conditional parameter as specified by the conceptor.

The user may interact with the system through the interface, to change the templates, and hence the text-language commentary included as insights in the report.

Insights may be hierarchical insights that are based on the use of a comparative factor by analyzing time series data, and determining the statistical properties like mean, and variance to generate commentary. In embodiments, a driver/offset analysis of metrics may be provided as insights. The various types of insights that can be generated by the framework may be determined by the conceptor and can vary depending on the type of digital report or presentation.

In step 240, the document may be generated based on the mapped skill and the retrieved data. In one embodiment, the document may be presentation, a text document, a web-based document, etc. The document may be any suitable size, including single pages, multiple pages, etc. In one embodiment, the document may be automatically printed and bound as is necessary and/or desired.

In step 245, the document may be provided to the user. In one embodiment, the document may be generated and electronically sent (e.g., email) to the user, may be created and provided to the user's electronic device, may be stored in a document library, may be printed and bound as necessary, etc.

It should be recognized that although several different embodiments are disclosed, these embodiments are not exclusive. Thus, although certain features may be disclosed in the context of one embodiment, the features may be used any embodiment as is necessary and/or desired.

Hereinafter, general aspects of implementation of the systems and methods of the embodiments will be described.

The system of the embodiments or portions of the system of the embodiments may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

1. A method for digital content generation using natural language interaction, comprising:
in an information processing apparatus comprising at least one computer processor:
receiving from an electronic device, a natural language command comprising an action to generate digital content, an object, and a data source for the digital content;
processing the natural language command to identify the action, a type of digital content, and the data source;
identifying a skill of a plurality of skills in a skill library that is mapped to the action and the object, wherein the natural language command is mapped to one or more skills of the plurality of skills;
retrieving data from the data source for the skill; and
generating the digital content according to the skill using the data.

2. The method of claim 1, wherein the natural language command is received as audio.

3. The method of claim 1, wherein the natural language command is received as text.

4. The method of claim 1, wherein the step of processing the natural language command to identify the action, the type of digital content, and the data source comprises:
parsing the natural language command into a plurality of words or phrases;
tokenizing the words or phrases; and
labeling the tokenized words or phrases.

5. The method of claim 4, wherein the object identifies automatically-creatable digital content.

6. The method of claim 1, further comprising:
training a natural language processing engine with a user preference for at least one of the action and the object.

7. The method of claim 1, wherein the skill comprises an atomic skill or a macro skill.

8. The method of claim 1, further comprising:
increasing a probability belief score in response to a successful mapping of the action and object to the skill; and
decreasing the probability belief score in response to an unsuccessful mapping of the action and object to the skill.

9. The method of claim 1, further comprising:
generating an insight for the digital content comprising textual content.

10. The method of claim 1, further comprising:
adding a new skill to the skill library based on the action and the object.

11. A system for digital content generation using natural language interaction, comprising:
an interface;
a parser;
a mapping engine;
a skill library;
a document generator
a data source;
wherein:
the interface receives, from an electronic device, a natural language command comprising an action to generate digital content, an object, and a data source for the digital content;
the parser processes the natural language command to identify the action, a type of digital content, and the data source;
the mapper identifies a skill of a plurality of skills in the skill library that is mapped to the action and the object, wherein the natural language command is mapped to one or more of the plurality of skills;
the document generator retrieves data from the data source for the skill; and
the document generator generates the digital content according to the skill using the data.

12. The system of claim 11, wherein the natural language command is received as audio.

13. The system of claim 11, wherein the natural language command is received as text.

14. The system of claim 11, wherein the parser processes the natural language command by:
parsing the natural language command into a plurality of words or phrases;
tokenizing the words or phrases; and
labeling the tokenized words or phrases.

15. The system of claim 14, wherein the object identifies automatically-creatable digital content.

16. The system of claim 11, further comprising a natural language processing engine that is trained with a user preference for at least one of the action and the object.

17. The system of claim 11, wherein the skill comprises an atomic skill or a macro skill.

18. The system of claim 11, wherein the document generator increases a probability belief score in response to a successful mapping of the action and object to the skill, and decreases the probability belief score in response to an unsuccessful mapping of the action and object to the skill.

19. The system of claim 11, further comprising:
an insights generator that generates an insight for the digital content comprising textual content.

20. The system of claim 11, wherein the mapping engine adds a new skill to the skill library based on the action and the object.
